(19) United States
(12) Patent Application Publication
(10) Pub. No.: US 2005/0171688 A1
(43) Pub. Date: Aug. 4, 2005

(54) Car navigation device

(75) Inventors: Teruhiko Fujita, Anjo-city (JP); Masatoshi Abou, Toyota-city (JP)

Correspondence Address: POSZ LAW GROUP, PLC, 12040 SOUTH LAKES DRIVE, SUITE 101, RESTON, VA, 20191, US

(73) Assignees: DENSO CORPORATION; TOYOTA JIDOSHA KABUSHIKI KAISHA

(21) Appl. No.: 11/038,280

(22) Filed: Jan. 21, 2005

(30) Foreign Application Priority Data
Jan. 30, 2004 (JP) 2004-24444

(51) Int. Cl. G01C 21/26

(52) U.S. Cl. 701/201; 701/209; 340/995.27

(57) ABSTRACT

A travel direction designating unit designates a travel direction of a travel lane where a subject vehicle travels, by using an image of a paint photographed by an in-vehicle camera. On the other hand, a travel direction extracting unit extracts a travel direction in which the subject vehicle should travel in line with a route to a destination from the current position of the subject vehicle. Further, a determining unit determines whether the extracted travel direction in line with the route matches with the designated travel direction. It is thereby determined whether the subject vehicle travels towards a proper road.

### CROSS REFERENCE TO RELATED APPLICATIONS

This application is based on and incorporates herein by reference Japanese Patent Application No. 2004-24444 filed on Jan. 30, 2004.

### FIELD OF THE INVENTION

The present invention relates to a car navigation device.

### BACKGROUND OF THE INVENTION

There is proposed a car navigation device that is used for determining a kind of a road where a subject vehicle provided with the car navigation device travels (refer to Patent Document 1). This proposed car navigation device determines a road kind whether an object specific to an expressway or a local road is present by using images photographed by a camera. This determination result is then used when a vehicle travels an area where a local road and an expressway are present close to each other. It is thereby determined whether the subject vehicle travels on a proper road.
Patent Document 1: JP-2003-279363 A

However, for instance, when a subject vehicle is about to move to another road belonging to a different road kind at a branching point ahead, the above navigation device cannot determine whether the subject vehicle travels on a proper road until the subject vehicle passes the branching point.

### SUMMARY OF THE INVENTION

It is an object of the present invention to provide a car navigation device capable of recognizing whether a subject vehicle provided with the car navigation device travels towards a proper road.

To achieve the above object, a car navigation device is provided with the following. A travel direction designating unit is included for designating a travel direction of a travel lane on a road where the vehicle travels. A position detecting unit is included for detecting a current position of the vehicle. A road data storing unit is included for storing road data. A route setting unit is included for setting a route from the detected current position to a destination based on the road data. Further, a travel direction determining unit is included for determining whether the designated travel direction matches with an on-route travel direction that is a travel direction in line with the set route. Here, a route guidance is performed based on a result determined by the travel direction determining unit.

In this structure, for instance, it is recognized that a subject vehicle travels on a travel lane moving towards a proper road, short of a branching point, a converging point, or an intersecting point.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a structure of a car navigation device according to an embodiment of the present invention;

FIG. 2 is a functional block diagram of a control circuit;

FIG. 3A is a view showing an area where a paint pattern is cut out;

FIG. 3B is a view of a cut-out paint pattern;

FIGS. 4A to 4D are views of templates for pattern matching;

FIGS. 5A to 5D are views showing movement of white lines during changing to the right travel lane;

FIG. 6 is a flow chart diagram showing a process of a route guidance by the car navigation device according to the embodiment; and

FIG. 7 is a view of an example where paints showing travel directions different from each other are disposed along a single lane according to a modification of the embodiment.

### DETAILED DESCRIPTION OF THE PREFERRED EMBODIMENTS

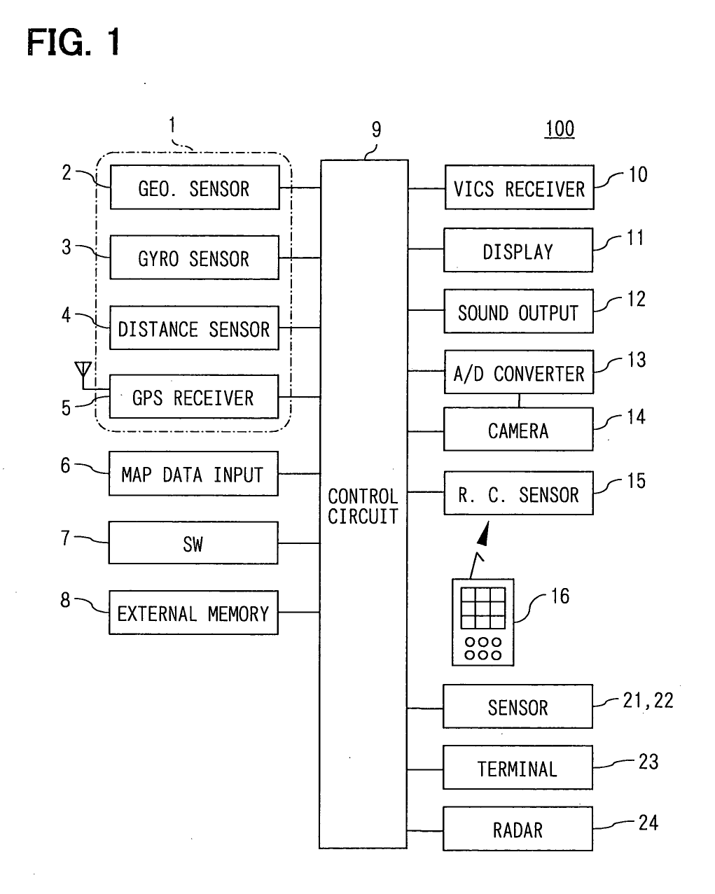

A car navigation device 100 according to an embodiment of the present invention will be explained with reference to drawings. The car navigation device 100 includes, as shown in FIG. 1, a position detector 1, a map data input unit 6, a manipulation switch group 7, an external memory 8, a control circuit 9, a VICS (Vehicle Information and Communication System) receiver 10, a display unit 11, a sound output unit 12, an A/D converter 13, a camera 14, a remote control sensor 15, and a remote controller 16.

The control circuit 9 is constructed of a known computer, including a CPU, a ROM, a RAM, an I/O, and a bus line interfacing with the foregoing components. A program executed by the control circuit 9 is written into the ROM. The CPU or the like executes given computing based on the program.

The position detector 1 includes a geomagnetism sensor 2 detecting an orientation of a travel direction of the subject vehicle mounted with the car navigation device 100, a gyroscope sensor 3 detecting an angular speed around a perpendicular direction of the subject vehicle, a distance sensor 4 detecting a traveled distance of the subject vehicle, and a GPS (Global Positioning System) receiver 5 for a differential GPS. This differential GPS accurately detects a current position of the subject vehicle based on radio waves from satellites and radio waves of an FM broadcast transmitted from a base station whose position is previously known. These sensors or the like 2, 3, 4, 5 include the respective errors different from each other, so that the sensors 2, 3, 4, 5 are used while being supplemented by one another.

Further, the position detector 1 can be constituted by a part of the sensors 2, 3, 4, 5 depending on the respective accuracies. Furthermore, a steering rotation sensor (not shown) or a vehicle speed sensor that detects a vehicle speed using rotation speeds of the following wheels can be also included in the position detector 1.

The map data input unit 6 is used for inputting map data including road data and landmark data. A storage medium for storing the map data can be a read-only medium such as a CD-ROM and a DVD-ROM, or a rewritable medium such as a memory card or a hard disk. Hereinbelow, link data and node data of the road data constituting the map data will be explained.

First, the road is formed by connecting links, each of which is between nodes. The node is a branching point, a converging point, an intersecting point, or the like. Link data includes a link ID identifying a link; a link length, coordinates of the starting and ending points of the link, a road name, a road kind, a road width, the number of lanes, and travel directions (e.g., direct advance, right turn, left turn, or the like) and layouts of the respective lanes.

In contrast, node data includes a node ID identifying a node, coordinates of the node, a node name, connecting link IDs showing the entire links connecting to the node, the number of lanes at any one of a branching point, a converging point, and an intersecting point, and travel directions and layouts of the respective lanes.

The manipulation switch group 7 can be a touch switch integrated into the display unit 11 or a mechanical switch to be used for various input. The VICS receiver 10 receives road traffic information distributed from the VICS center via a beacon laid on a road or a local FM broadcast.

The road traffic information includes congestion information such as congestion degrees of the respective links, or a travel time period (required moving time period); and regulation information such as traffic closure due to an accident or a construction or closure of entrance/exit of an expressway. Here, the congestion degree is represented by multiple estimate stages (e.g., heavily congested, crowded, empty, or the like). The received road traffic information is processed by the control circuit 9. For instance, the congestion information or the regulation information can be shown in the screen of the display unit 11 while being superimposed on the map.

Further, road surface information (road surface state of being dry, wet, frozen, snowed, or the like) or congestion information can be obtained via a mobile communications unit (e.g., a cell phone) from a provider such as a specific traffic information provider that provides traffic information.

The display unit 11 is constructed of, e.g., a liquid crystal display, showing on its screen, a subject-vehicle position mark corresponding to a current position inputted from the position detector 1, and a road map surrounding the subject vehicle generated by the map data inputted from the map data input unit 6. The sound output unit 12 is constructed of a speaker, an audio amplifier, or the like for performing voice guidance or the like.

The A/D converter 13 converts analog signals outputted from the camera 14 to digital signals, then to output them to the control circuit 9. The camera 14 is used as an imaging unit for photographing an image forward of the subject vehicle or an image rearward of the subject vehicle. The camera 14 controls gains, shutter speeds, frame rate, by receiving their signals from the control circuit 9. The camera 14 outputs pixel value signals indicating a brightness of each pixel of a photographed image as horizontal and vertical synchronous signals to the control circuit 9.

The car navigation device 100 includes a route guiding function. In this function, the most proper guiding route is automatically set from the current position (or starting point designated by a user) to a destination when the position of the destination is inputted from the remote controller 16 via the remote control sensor 15; then, the subject vehicle is guided to the destination while the map displayed based on advancing of the subject vehicle. Such a method for automatically setting the most proper route includes a known method such as the Dijkstra method.

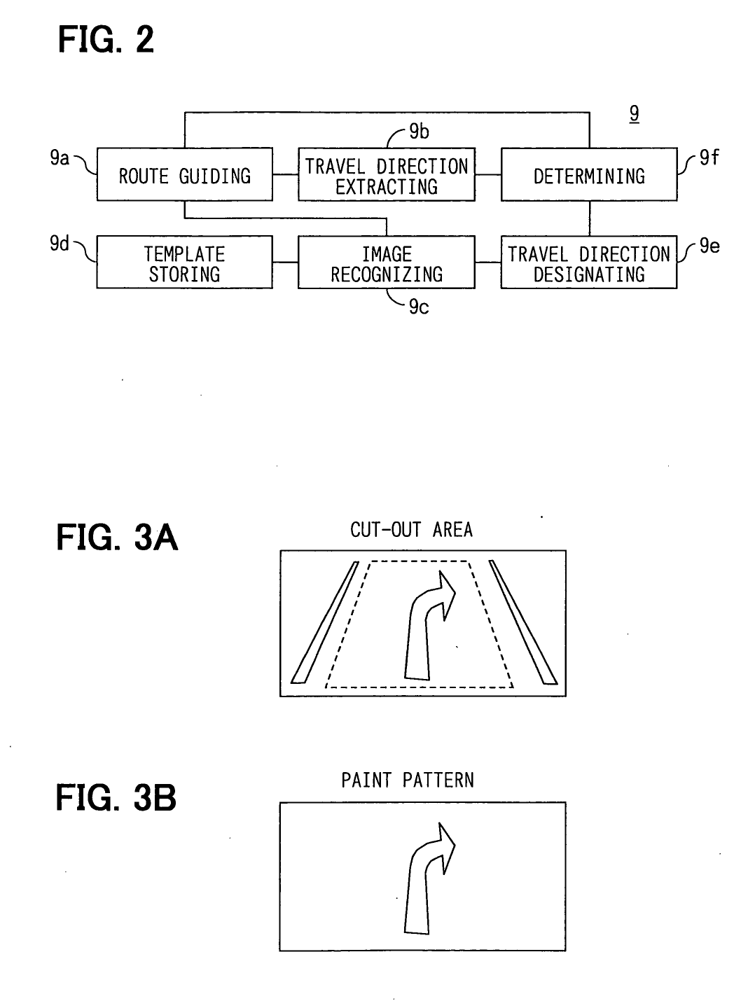

The control circuit 9 includes, as shown in FIG. 2, a route guiding unit 9a, a travel direction extracting unit 9b, an image recognizing unit 9c, a template storing unit 9d, a travel direction designating unit 9e, and a determining unit 9f.

The route guiding unit 9a gives to the image recognizing unit 9c an instruction of executing an image recognition process when the current position of the subject vehicle enters within a given distance to any one of a branching point, a converging point, and an intersecting point that is along the route and has multiple lanes, while executing the above route guiding function.

The travel direction extracting unit 9b extracts a travel direction (or on-route travel direction) in which the subject vehicle should travel in line with the route from the road data (link data, node data) constituting the map data of the map data input unit 6. Here, the on-route travel direction in which the subject vehicle should travel can be extracted from the shape of the route on the map.

The image recognizing unit 9c executes an image recognizing process that recognizes a white line or a direction indicating object including a direction indicator (or paint) that is provided to a road for indicating a travel direction, from the images photographed by the camera 14, as shown in FIG. 3A. In this embodiment, a cut-out area for cutting out a paint, shown in FIG. 3A, is set such that white lines on a road are first recognized and an area between the recognized white lines is set as a cut-out area. However, a cut-out area can correspond to a portion between the white lines on the photographed image.

In this recognizing method for a paint, for instance, the photographed image is converted to a binary image; a white line is recognized from the binary image; a cut-out area is set to a portion between the white lines; and an outline of a paint shown in FIG. 3B is then extracted by connecting pixels constituting edges of the binary image within the cut-out area.

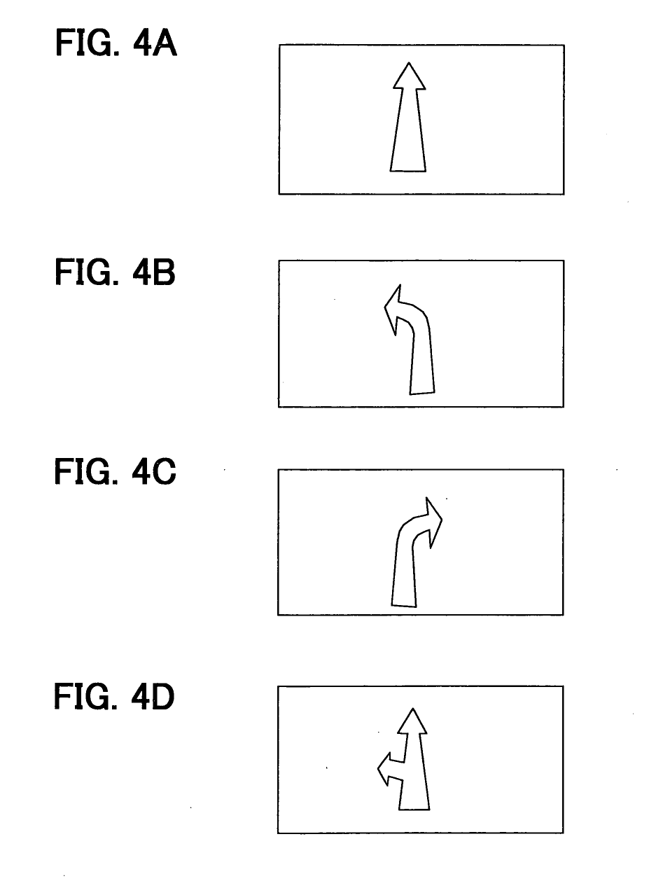

Next, a template matching is executed as follows. The outline of a paint undergoes pattern matching with templates, shown in FIGS. 4A to 4D, stored in the template storing unit 9d. Then, the template most highly matching is recognized. Thus, the paint is recognized from the image photographed by the camera 14, so that a travel direction of the travel lane is designated by the direction shown by the recognized paint.

Note that, when edges cannot be detected from the binary image because of haziness of the paint or the like, the image recognizing process is stopped (prohibited). This prevents mis-recognition.

The image recognizing unit 9c starts the above process when receiving the instruction of executing the image recognizing process from the route guiding unit 9a. That is, generally, at an intersection such as a branching point, a converging point, or an intersecting point having multiple travel lanes, the respective lanes have different travel directions. Therefore, the image recognizing process is executed only when the subject vehicle approaches an intersection that has multiple lanes. This leads to recognition of a travel direction of the subject vehicle and decrease in the processing load required for the image recognizing process. Here, when the instruction of executing the image recognizing process is received, the camera 14 can be activated to photograph an image and execute the image recognizing process.

Further, the image recognizing unit 9c detects an optical flow of pixels corresponding to the recognized white lines (i.e., movement of the recognized white lines) to thereby detect a travel lane change to the adjacent lane (i.e., lane change) from the detection result.

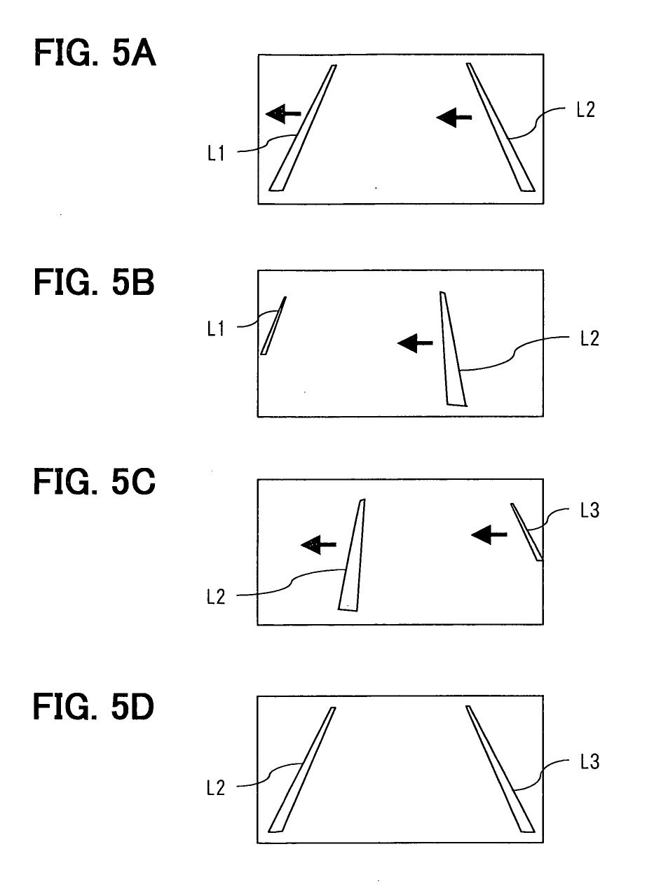

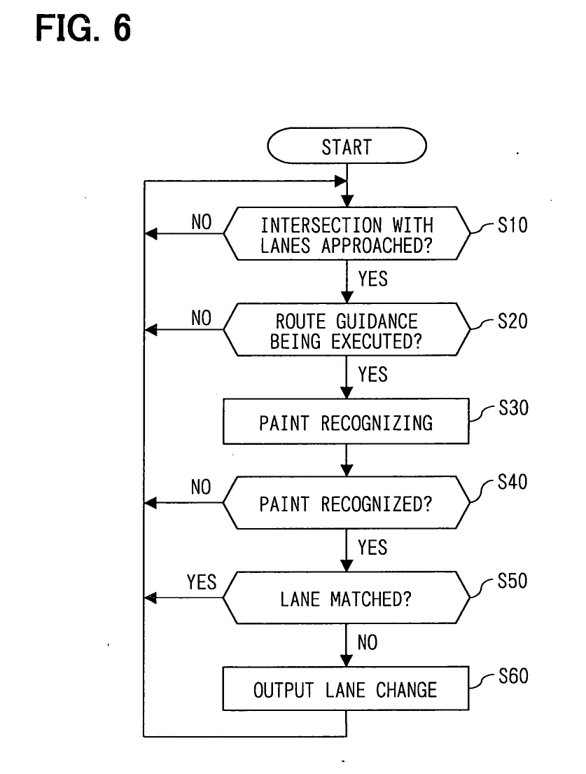

For instance, refer to FIGS. 5A to 5D, when the vehicle changes to the travel lane located at the right side of the vehicle, the white lines L1, L2 shown in FIG. 5A move leftward as shown in FIG. 5B. When the vehicle further moves, the new white line L3 is detected as shown in FIG. 5C. Thereafter, as shown in FIG. 5D, the white lines L2, L3 are detected. This optical flow of the white lines can be detected by, for instance, a known block matching, an inclination method, a filtering method, or a two-time differentiation.

Note that, even when a road or an intersection has no white lines, a travel lane change of a vehicle can be detected by using a movement distance or a movement direction obtained from the distance sensor 4 and the geomagnetism sensor 2.

The travel direction designating unit 9e designates a travel direction of a travel lane where the subject vehicle travels by using the direction shown by the recognized paint. Further, when a travel lane change to the adjacent lane is detected, the effect that the travel lane is changed is notified the determining unit 9f.

The determining unit 9f executes a determining process that determines whether the travel direction based on the paint designated by the travel direction designating unit 9e matches with the on-route travel direction in line with the route extracted by the travel direction extracting unit 9b. When it is determined that it does not match, an instruction of outputting a guidance that urges a travel lane change is sent to the route guiding unit 9a.

Further, when receiving from the travel direction designating unit 9e the effect that the travel lane change is detected, the determining unit 9f executes the determining process again. For instance, suppose the case where a user intentionally changes a travel lane to the adjacent lane so as to avoid an obstacle such as a parked vehicle. In this case, it is determined whether the travel lane to which the vehicle has changed is a proper road in line with the route.

When receiving the instruction from the determining unit 9f, the route guiding unit 9a performs a travel lane change guidance that urges a travel lane change to a travel lane where the subject vehicle should travel. Thus, by changing the travel lane based on the travel lane change guidance, the subject vehicle can change the travel lane to the proper travel lane approaching the proper road accurately following the route.

Further, the route guiding unit 9a can only notify that the travel lane of the subject vehicle is different from the on-route travel lane. A user of the subject vehicle can thereby recognize that the subject vehicle does not travel the travel lane approaching the proper road in line with the route.

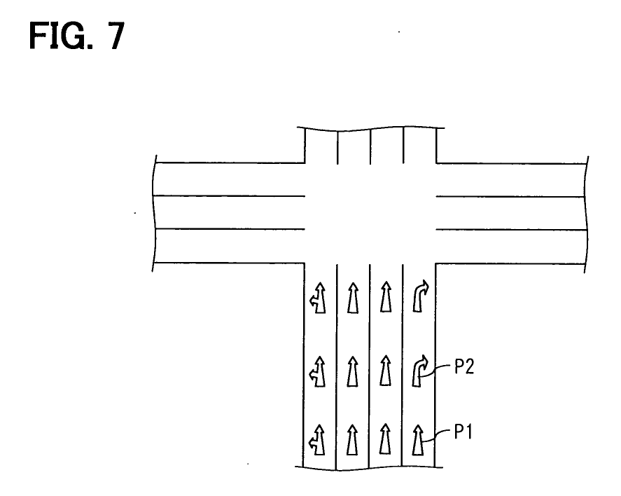

Next, a route guiding process by the car navigation device 100 will be explained with reference to FIG. 7.

At Step S10, it is determined whether the subject vehicle enters within a given distance to an intersection including a branching point, a converging point, and an intersecting point that has multiple lanes. When affirmatively determined, the process advances to Step S20. In contrast, when negatively determined, the process enters a waiting state until the subject vehicle enters within the given distance.

At Step S20, it is determined whether a route guiding function is being executed. When affirmatively determined, the process advances to Step S30. In contrast, when negatively determined, the process returns to Step S10, to repeat the above processing.

At Step S30, an image recognizing process that recognizes a paint on a road is executed. At Step S40, it is determined whether a paint is recognized. When affirmatively determined, the process advances to Step S50. In contrast, when negatively determined, the process returns to Step S10, to repeat the above processing.

At Step S50, it is determined whether the travel lane based on the recognized paint matches with the travel lane where the subject vehicle should travel along the route. When affirmatively determined, the process returns to Step S10, to repeat the above processing. In contrast, when negatively determined, the process advances to Step S60, where a guidance that urges a travel lane change is outputted.

Thus, in the car navigation device 100, a travel direction of a travel lane is designated from an image of a paint photographed by the camera 14 mounted in the subject vehicle; a travel lane where the subject vehicle should travel on the route to the destination from the current position is extracted; and it is determined whether the travel lane of the travel lane where the subject vehicle travels matches with the travel lane where the subject vehicle should travel in line with the route. Further, when it is determined that it does not match, a guidance that urges a travel lane change to the travel lane where the subject vehicle should travel. Thus, whether the subject vehicle travels on the travel lane approaching the proper road can be recognized. Further, when the subject vehicle travels on the lane deviated from the route, a travel lane change to the travel lane properly approaching the road in line with the route can be performed.

(Modification 1)

For instance, in an intersection or the like having multiple lanes, as shown in FIG. 7, there is a case where multiple paints P1, P2 having different travel directions are shown in a single lane. When a route to turn to the right at the intersection is set, the subject vehicle travels on the rightmost lane to approach the intersection (i.e., approaches the intersection by using a proper lane in line with the route). Here, in the car navigation device 100 of this embodiment, when the paint P1 is recognized, it is determined that the subject vehicle travels on a lane not following the route. A guidance urging a travel lane change is thereby unfavorably outputted.

To solve this inexpedience experienced in FIG. 7, when paints showing multiple different travel directions are present in a single lane, the determining unit 9f eventually determines by using, among the travel directions designated by the travel direction designating unit 9e, the travel direction designated closer to the intersection. On the other hand, the travel direction designated further to the intersection is used as reference information.

Thus, even when a single lane has paints showing multiple different travel directions, the travel direction of the travel lane the closest to the intersection is used for determining.

(Modification 2)

In the above embodiment, the car navigation device 100 recognizes a paint on a travel lane to thereby designate a travel direction of a travel lane where the subject vehicle travels. However, for instance, destination signs, as direction indicating objects, disposed in expressways or the like can be used for this purpose. Here, the destination signs show a destination of a travel lane.

In this modification, the camera 14 photographs an image of a destination sign; the image recognizing unit 9c recognizes the destination sign from the photographed image; and, the travel direction designating unit 9e designates a travel direction of a travel lane where the subject vehicle travels from the recognized destination sign. Here, the designated travel direction is a direction selected when the subject vehicle advances from the current position to the destination indicated by the destination sign. Further, the determining unit 9f determines whether the designated travel direction of the travel lane matches with the travel direction that the subject vehicle should travel in line with the route.

Thus, for instance, using destination signs that are often disposed in an expressway such as Metropolitan Expressway, it is determined whether the subject vehicle travels the travel lane that leads the subject vehicle to the proper road in line with the route.

Otherwise, the travel direction designating unit 9e can designate a destination of a travel lane of the subject vehicle from the recognized destination sign, while the determining unit 9f can determine whether the designated destination matches with the destination (or passing point) of the route.

(Modification 3)

In the above embodiment, the car navigation device 100 recognizes a paint on a travel lane to thereby designate a travel direction of a travel lane where the subject vehicle travels. However, it can be different as follows. The image recognizing unit 9c recognizes the number of white lines on the road where the subject vehicle travels and the positions of the white lines; further, based on them, the image recognizing unit 9c recognizes the number of travel lanes on the road and the position of the travel lane where the subject vehicle travels. Then, based on them, the travel direction designating unit 9e designates the travel direction of the travel lane where the subject vehicle travels.

That is, for instance, in the case where two travel lanes are present in a road the subject vehicle travels, in general, in Japan, the travel direction of the right lane is the straight direction and/or the right direction, while the travel direction of the left lane is the straight direction and/or the left direction.

Further, for instance, in the case where three travel lanes are present in a road the subject vehicle travels, in general, in Japan, the travel direction of the right lane is the straight direction and/or the right direction; the travel direction of the central lane is the straight direction; and the travel direction of the left lane is the straight direction and/or the left direction.

Further, for instance, in the case where four travel lanes are present in a road the subject vehicle travels, in general, in Japan, the travel direction of the rightmost lane is the straight direction and/or the right direction; the travel direction of the leftmost lane is the straight direction and/or the left direction; and the travel directions of the central two lanes are the straight directions.

Thus, the travel direction of the travel lane can be designated based on the number of travel lanes and the position of the travel lane where the subject vehicle travels.

(Modification 4)

In the above embodiment, the car navigation device 100 recognizes a paint on a travel lane to thereby designate a travel direction of a travel lane where the subject vehicle travels. However, the travel direction of the travel lane can be designated using information externally obtained.

That is, for instance, travel lane information including a travel direction of a travel lane where another vehicle travels, and a vehicle registration number of another vehicle is obtained via a mobile communications terminal 23 shown in FIG. 1; an image of a license plate of a preceding vehicle is obtained from an image photographed by the camera 14; an image recognizing process that recognizes the vehicle registration number of the preceding vehicle from the photographed image is performed by the image recognizing unit 9c; the travel lane information including the vehicle registration number matching with the recognized vehicle registration number is extracted from the travel lane information obtained by the mobile communications terminal 23; the travel direction of the extracted travel lane information is designated as the travel direction of the travel lane where the subject vehicle travels.

Thus, the travel direction of the travel lane can be designated based on the travel lane information of the preceding vehicle that travels on the same travel lane where the subject vehicle travels. Further, via the mobile communications terminal 23, the travel lane information of the subject vehicle can be outwardly transmitted that includes the travel direction of the travel lane where the subject vehicle travels and the vehicle registration number of the subject vehicle. This enables the travel lane information of the subject vehicle to be transmitted to a following vehicle.

(Modification 5)

In the above embodiment, the car navigation device 100 recognizes a paint on a travel lane to thereby designate a travel direction of a travel lane where the subject vehicle travels. However, the travel direction of the travel lane can be designated by using the current position of the subject vehicle detected by the GPS receiver 5.

That is, the differential GPS can obtain the position detection accuracy of several meters. Therefore, the travel direction of the subject vehicle corresponding to the current position detected by the GPS receiver 5 is retrieved from the road data, so that the travel direction of the subject vehicle can be designated. Further, it is favorable that the detection result of the GPS receiver 5 and another detection result of the geomagnetism sensor 2, the gyroscope sensor 3, the distance sensor 4 or the like are combined so that more accurate position detection can be obtained.

(Modification 6)

In the above embodiment, when edges cannot be detected from the binary image because of haziness of the paint or the like, the image recognizing process is prohibited from being executed. This thereby prevents mis-recognition. Here, the image recognizing process can be prohibited when it is determined that a paint is unable to be recognized.

For instance, when a road surface condition is snowed, the paint on the road is hidden by the snow to be thereby unable to be imaged. When the subject vehicle travels in a congested road, the paint on the road is hidden by the preceding vehicle to be thereby unable to be imaged. When an obstacle or a falling object is present ahead of the subject vehicle, the paint on the road is hidden by the obstacle or the falling object to be thereby unable to be imaged.

Further, when an operation of the wiper on the windshield or raining is detected, the weather is supposed to be rainy or snowy. Under such bad weather, reflection light from the road increases, so that recognition accuracy for the paint on the road remarkably decreases.

To deal with these cases, for instance, road surface information or traffic congestion information is obtained from the VICS receiver 10 or a specific traffic information provider. When the road corresponding to the current position of the subject vehicle is under being snowed up or under congestion, the image recognizing process is prohibited.

Otherwise, a radar device 24 (in FIG. 1) using radio waves of laser or milli-meter wave can be provided in the subject vehicle. When the radar device 24 detects, ahead of the subject vehicle, an obstacle that overlaps with a paint, the image recognizing process is prohibited.

Further, a sensor 21 (in FIG. 1) that detects an operation of the windshield wiper or a raindrop sensor 22 (FIG. 1) that detects raining on the subject vehicle can be provided in the subject vehicle. When these sensors 21, 22 detect the operation of the windshield wiper or the raining, the image recognizing process is prohibited.

Thus, the image recognizing process can be prohibited from being executed when it is determined that a paint is unable to be recognized. The mis-recognition of a paint can be thereby prevented. Here, this Modification 6 can be applied to Modifications 1, 2.

(Modification 7)

The car navigation device 100 can include all the structures of the above embodiment and Modifications 2 to 5. Further, the travel direction of the travel lane can be determined in a comprehensive way based on at least two designation results from the travel direction designating units 9e of the above embodiment and Modifications 2 to 5. This enables the travel direction of the travel lane where the subject vehicle travels to be accurately designated.

Further, this Modification 7 can include Modification 6. Further, when the image recognizing process that recognizes paints, destination signs, or white lines is prohibited, the travel direction of the travel lane where the subject vehicle travels can be designated by using at least one of the travel direction designating units 9e of Modifications 4, 5.

As explained above, even when the image recognizing process is prohibited, the travel direction of the travel lane where the subject vehicle travels can be designated by using the lane information from a preceding vehicle or by using the result of the reference to the road data regarding the travel direction of the travel lane of the road corresponding to the current position of the subject vehicle.

It will be obvious to those skilled in the art that various changes may be made in the above-described embodiments of the present invention. However, the scope of the present invention should be determined by the following claims.

1. A car navigation device provided in a vehicle, the car navigation device comprising:
a travel direction designating unit that designates a travel direction of a travel lane on a road where the vehicle travels;
a position detecting unit that detects a current position of the vehicle;
a road data storing unit that stores road data;
a route setting unit that sets a route from the detected current position to a destination based on the road data; and
a travel direction determining unit that determines whether the designated travel direction matches with an on-route travel direction that is a travel direction in line with the set route,
wherein a route guidance is performed based on a result determined by the travel direction determining unit.

2. The car navigation device of claim 1, further comprising:
a controlling unit that executes, when the designated travel direction does not match with the on-route travel direction, a control process that notifies an effect that the designated travel direction does not match with the on-route travel direction.

3. The car navigation device of claim 2,
wherein the controlling unit execute a control process that executes a travel direction change guidance that urges to change the designated travel direction to the on-route travel direction.

4. The car navigation device of claim 1, further comprising:
an imaging unit that photographs an image of a direction indicating object provided to a road for indicating a travel direction; and
an image recognizing unit that executes a recognizing process that recognizes the direction indicating object based on the photographed image,
wherein the travel direction designating unit designates the travel direction based on the recognized direction indicating object.

5. The car navigation device of claim 4,
wherein the direction indicating object provided to a road for indicating a travel direction includes a direction indicator provided on a road for indicating a travel direction.

6. The car navigation device of claim 4,
wherein the direction indicating object provided to a road for indicating a travel direction includes a destination sign provided over a road for indicating a destination.

7. The car navigation device of claim 4,
wherein, when the vehicle approaches a point on a single travel lane, wherein the point includes one of a branching point, a converging point, and an intersecting point, wherein multiple different travel directions are designated on the single travel lane while the vehicle approaches the point, the travel direction determining unit determines based on a travel direction designated closer to the point.

8. The car navigation device of claim 4,
wherein the imaging unit photographs an image including a white line provided on a road, and
wherein the image recognizing unit executes a recognizing process that recognizes the white line based on the photographed image,
the car navigation device, further comprising:
a white line movement detecting unit that detects a movement of the recognized white line;
a vehicle movement detecting unit that detects a movement distance and a movement direction of the vehicle; and
a travel lane change detecting unit that detects a travel lane change to a travel lane adjacent to the travel lane where the vehicle travels from at least one of two results detected by the white line movement detecting unit and the vehicle movement detecting unit,
wherein, when the travel lane change is detected, the travel direction determining unit determines using the travel direction designated after the travel lane change is completed.

9. The car navigation device of claim 8, further comprising:
a controlling unit that executes, when the designated travel direction does not match with the on-route travel direction, a control process that executes a travel direction change guidance that urges to change the travel direction where the vehicle travels, to the on-route travel direction,
wherein, when the travel lane change is detected after the control process is executed, the travel direction determining unit determines.

10. The car navigation device of claim 4, further comprising:
an instructing unit that gives an instruction of executing the recognizing process to the image recognizing unit when the vehicle enters within a given distance to a point that includes at least one of a branching point, a converging point, and an intersecting point, wherein a position corresponding to the point is stored in the road data storing unit,
wherein the image recognizing unit executes the recognizing process when the instruction is received.

11. The car navigation device of claim 10,
wherein the road data storing unit stores as the road data the number of travel lanes on the road, and
wherein the instructing unit gives the instruction of executing the recognizing process when the vehicle enters within the given distance to the point.

12. The car navigation device of claim 4, further comprising:
a road data obtaining unit that obtains road information including at least one of traffic congestion information and road surface information relating to the travel direction where the vehicle travels;
an object detecting unit that detects an obstacle present ahead of the vehicle;
a wiper detecting unit that detects an operation of a wiper of the vehicle;
a rain detecting unit that detects raining on the vehicle; and
a state determining unit that determines whether it is difficult to recognize the image based on at least one of a result obtained by the road data obtaining unit, a result detected by the object detecting unit, a result detected by the wiper detecting unit, and a result detected by the rain detecting unit,
wherein the image recognizing unit includes a recognizing process prohibiting unit that prohibits, when it is determined that it is difficult to recognize the image, the image recognizing process from being executed.

13. The car navigation device of claim 1, further comprising:
a different-vehicle travel-lane information obtaining unit that externally obtains different-vehicle travel-lane information including a travel direction of a travel lane where a different vehicle travels and a vehicle registration number of the different vehicle;
a license plate imaging unit that photographs an image of a license plate of a preceding vehicle ahead of the vehicle;
a license plate image recognizing unit that executes a recognizing process that recognizes a vehicle registration number of the preceding vehicle based on the photographed image; and
a travel lane information extracting unit that extracts travel lane information including the recognized vehicle registration number from the different-vehicle travel-lane information obtained by the different-vehicle travel-lane information obtaining unit,
wherein the travel direction designating unit designates, as the travel direction of the travel lane where the vehicle travels, a travel lane included in the extracted travel lane information.

14. The car navigation device of claim 1, further comprising:
a white line imaging unit that photographs an image of a white line provided on a road;
a white line image recognizing unit that executes a recognizing process that recognizes the white line based on the photographed image;
a travel lane recognizing unit that recognizes a number of travel lanes on the road where the vehicle travels and a current position of the travel lane where the vehicle travels, based on a number of the recognized white lines and positions of the recognized white lines,
wherein the travel direction designating unit designates the travel direction based on the recognized number of travel lanes and the recognized current position of the travel lane where the vehicle travels.

15. The car navigation device of claim 14, further comprising:
a white line movement detecting unit that detects a movement of the recognized white line;
a vehicle movement detecting unit that detects a movement distance and a movement direction of the vehicle; and
a travel lane change detecting unit that detects a travel lane change to a travel lane adjacent to the travel lane where the vehicle travels, from at least one of two results detected by the white line movement detecting unit and the vehicle movement detecting unit,
wherein, when the travel lane change is detected, the travel direction determining unit determines using the travel direction designated after the travel lane change is completed.

16. The car navigation device of claim 15, further comprising:
a controlling unit that executes, when the designated travel direction does not match with the on-route travel direction, a control process that executes a travel direction change guidance that urges to change the designated travel direction to the on-route travel direction,
wherein, when the travel lane change is detected after the control process is executed, the travel direction determining unit determines.

17. The car navigation device of claim 1,
wherein the road data storing unit stores as the road data road data including travel directions of respective travel lanes of the road, and
wherein the travel direction designating unit designates the travel direction by retrieving from the road data a travel direction of a travel lane corresponding to the current position of the vehicle.

18. The car navigation device of claim 1, further comprising:
an indicator imaging unit that photographs an image of a direction indicator provided on a road for indicating a travel direction;
an indicator image recognizing unit that executes a recognizing process that recognizes the direction indicator based on the photographed image, wherein the travel direction designating unit includes a first designating unit that designates the travel direction based on the recognized direction indicator;
a sign imaging unit that photographs an image of a destination sign provided over a road for indicating a destination;
a sign image recognizing unit that executes a recognizing process that recognizes the destination sign based on the photographed image, wherein the travel direction designating unit includes a second designating unit that designates the travel direction based on the recognized destination sign;
a different-vehicle travel-lane information obtaining unit that externally obtains different-vehicle travel-lane information including a travel direction of a travel lane where a different vehicle travels and a vehicle registration number of the different vehicle;
a license plate imaging unit that photographs an image of a license plate of a preceding vehicle ahead of the vehicle;
a license plate image recognizing unit that executes a recognizing process that recognizes a vehicle registration number of the preceding vehicle based on the photographed image;
a travel lane information extracting unit that extracts travel lane information including the recognized vehicle registration number from the different-vehicle travel-lane information obtained by the different-vehicle travel-lane information obtaining unit, wherein the travel direction designating unit includes a third designating unit that designates, as the travel direction where the vehicle travels, a travel lane included in the extracted travel lane information based on the recognized destination sign;
a white line imaging unit that photographs an image of a white line provided on a road;
a white line image recognizing unit that executes a recognizing process that recognizes the white line based on the photographed image;
a travel lane recognizing unit that recognizes a number of travel lanes on the road where the vehicle travels and a current position of the travel lane where the vehicle travels, based on a number of the recognized white lines and positions of the recognized white lines, wherein the travel direction designating unit includes a fourth designating unit that designates the travel direction based on the recognized number of travel lanes and the recognized current position of the travel lane where the vehicle travels,
wherein the road data storing unit stores as the road data road data including travel directions of respective travel lanes of the road,
wherein the travel direction designating unit includes a fifth designating unit that designates the travel direction by retrieving a travel direction of a travel lane corresponding to the current position of the vehicle from the road data; and
a travel direction concluding unit that concludes a travel direction of the travel lane where the vehicle travels based on at least two results of five results respectively designated by the first designating unit, the second designating unit, the third designating unit, the fourth designating unit, and the fifth designating unit,
wherein the travel direction determining unit determines whether the travel direction concluded by the travel direction concluding unit matches with the on-route travel direction.

19. The car navigation device of claim 18, further comprising:
a road data obtaining unit that obtains road information including at least one of traffic congestion information and road surface information relating to the travel direction where the vehicle travels;
an object detecting unit that detects an obstacle present ahead of the vehicle;
a wiper detecting unit that detects an operation of a wiper of the vehicle;
a rain detecting unit that detects raining on the vehicle; and
a state determining unit that determines whether it is difficult to recognize the image based on at least one of a result obtained by the road data obtaining unit, a result detected by the object detecting unit, a result detected by the wiper detecting unit, and a result detected by the rain detecting unit,
wherein the image recognizing unit includes a recognizing process prohibiting unit that prohibits, when it is determined that it is difficult to recognize the image, the image recognizing process from being executed, and
wherein, when the image recognizing process is prohibited from being executed by the recognizing process prohibiting unit, the travel direction concluding unit concludes the designated travel direction based on at least one result of two results respectively designated by the third designating unit and the fifth designating unit.

20. The car navigation device of claim 18, further comprising:
a controlling unit that executes, when the concluded travel direction does not match with the on-route travel direction, a control process that notifies an effect that the concluded travel direction does not match with the on-route travel direction.

21. The car navigation device of claim 20,
wherein the controlling unit execute a control process that executes a travel direction change guidance that urges to change the concluded travel direction to the on-route travel direction.

22. The car navigation device of claim 1, further comprising:
a transmitting unit that externally transmits travel lane information including the designated travel lane and a vehicle registration number of the vehicle.

23. The car navigation device of claim 18, further comprising:
a transmitting unit that externally transmits travel lane information including the concluded travel lane and a vehicle registration number of the vehicle.
